(19) United States
(12) Patent Application Publication
(10) Pub. No.: US 2023/0239527 A1
(43) Pub. Date: Jul. 27, 2023

(54) Automation of User-Initiated Content Modification

(71) Applicant: Disney Enterprises, Inc., Burbank, CA (US)

(72) Inventors: Yazmaliza Yaacob, Burbank, CA (US); Christopher M. Tolle, Pasadena, CA (US); William Sevilla, Aliso Viejo, CA (US); Marcos N. Stillo, Burbank, CA (US); Sang Hee Lee, Sherman Oaks, CA (US)

(21) Appl. No.: 17/584,226

(22) Filed: Jan. 25, 2022

(51) Int. Cl. H04N 21/2668; H04N 21/239; H04N 21/25

(52) U.S. Cl. CPC H04N 21/2668; H04N 21/2393; H04N 21/251

(57) ABSTRACT

A system for performing user-initiated content modification includes a computing platform having processing hardware and a system memory storing a software code. The processing hardware is configured to execute the software code to receive a request to perform a modification to content, determine, in response to the request, whether the modification is permissible or impermissible, and when the modification is determined to be impermissible, deny the request. When the modification is determined to be permissible, the processing hardware is configured to further execute the software code to obtain the content, obtain or produce alternate content for use in modifying the content per the request, and perform the modification to the content, using the alternate content, to provide modified content.

### BACKGROUND

As digital content has become more prevalent, the desire to personalize or tailor content to a user's preferences has increased. A user's preferences may vary, for example, based on geographic location, demographics, personal values, experiences, beliefs, the presence of others (e.g., children) during the viewing experience, or the like. In addition, the standards by which users judge the desirability of images, sounds, and language present in that content may change, for example, over time or between instances of content consumption. Because the desirability of particular images, sounds, language, or a combination thereof can vary widely among users, making global modifications to content is insufficient in many instances.

At present, the correction of undesirable images, sounds, or language included in existing content requires that each source content file be searched for the content requiring correction, and that such content be removed or replaced by one or more of imagery, sounds, and language that is/are preferred by the content owner or distributor. Then, that new source content is provided to the digital platforms that deliver content to consumers. As other content presently deemed to be acceptable becomes undesirable in the future, the same search, removal or replacement, and redistribution process would need to be repeated. Due to the present pace at which society is becoming more culturally sensitive and inclusive, the existing techniques for correcting content are too cumbersome, laborious, and costly to be practical. In addition, the existing techniques do not account for an individual consumer's preferences. Further, the existing techniques do not allow for changes to be made between instances of content consumption.

### BRIEF DESCRIPTION OF THE DRAWINGS

FIG. 1 shows a diagram of an exemplary automated system for performing user-initiated content modification, according to one implementation;

FIG. 2 shows a more detailed diagram of a consumer device communicatively coupled to the system shown in FIG. 1, according to one implementation;

FIG. 3 shows a flowchart outlining an exemplary method for performing user-initiated content modification, according to one implementation;

FIG. 4 shows a flow diagram outlining a process for data collection, content modification, and storage of modified content, according to one implementation;

FIG. 5 shows a flow diagram outlining a process for modifying content on-the-fly, according to one implementation; and

FIG. 6 shows a flow diagram outlining a process for producing alternate content for use in modifying existing content, according to one implementation.

### DETAILED DESCRIPTION

The following description contains specific information pertaining to implementations in the present disclosure. One skilled in the art will recognize that the present disclosure may be implemented in a manner different from that specifically discussed herein. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

The present application discloses automated systems and methods for performing user-initiated content modification. It is noted that although the present user-initiated content modification solution is described below in detail by reference to the exemplary use case in which audio-video (A/V) content having audio, video, and captioning components is modified, the present novel and inventive principles may be advantageously applied to A/V content from which text captioning is omitted, to video unaccompanied by audio or text, to audio content unaccompanied by video or text, to video and text unaccompanied by audio, to audio and text unaccompanied by video, or to text alone. Moreover, as noted above, the systems and methods disclosed by the present application may advantageously be substantially or fully automated.

As defined for the purposes of the present application, the terms “automation.” “automated”, and “automating” refer to systems and processes that do not require the participation of a human system administrator. Although in some implementations, a human editor or system administrator may review the performance of the automated systems and methods described herein, that human involvement is optional. Thus, the methods described in the present application may be performed under the control of hardware processing components of the disclosed automated systems.

It is also noted that, as defined for the purposes of the present application, the term “user” refers to a content stakeholder, such as a content owner, a content distributor, or a consumer of content, for example. Thus. “user-initiated” content modification refers to changes to existing content made in response to a request or demand by a content stakeholder.

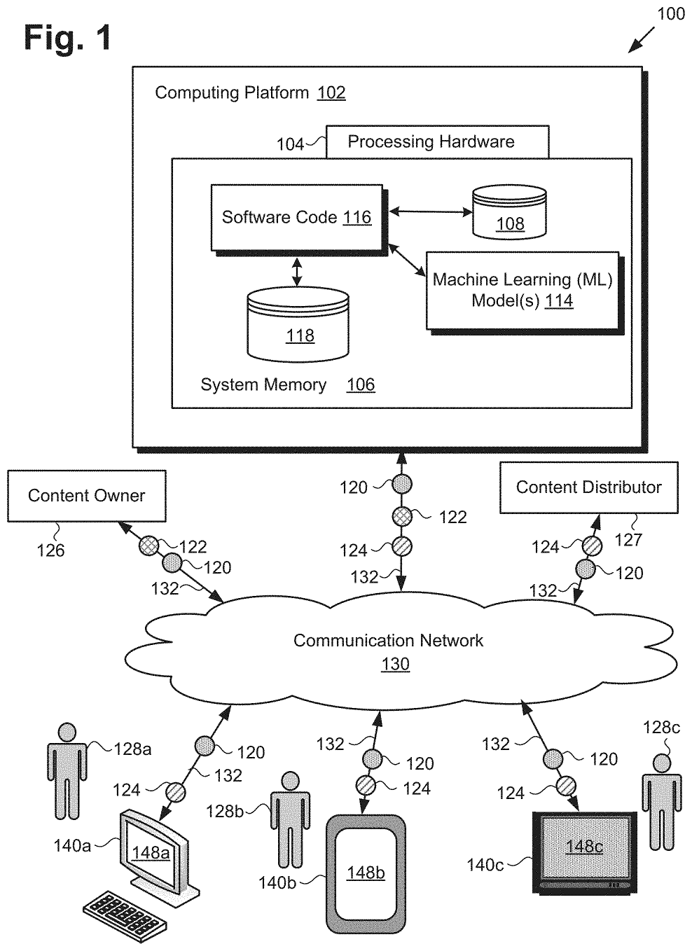

FIG. 1 shows an exemplary automated system for performing user-initiated content modification, according to one implementation. As shown in FIG. 1, system 100 includes computing platform 102 having processing hardware 104 and system memory 106 implemented as a computer-readable non-transitory storage medium or cloud solutions. According to the present exemplary implementation, system memory 106 stores software code 116, and in some implementations, may store one or more trained machine learning (ML) models 114 (hereinafter “trained ML model(s) 114”), initial and alternate content database 108, and modified content database 118.

It is noted that, as defined in the present application, the expression “trained machine learning model” or “trained ML model” may refer to a mathematical model for making future predictions based on patterns learned from samples of data or “training data.” Various learning algorithms can be used to map correlations between input data and output data. These correlations form the mathematical model and pre-determined algorithm that can be used to make future predictions on new input data. Such a predictive model may include one or more logistic regression models. Bayesian models, or neural networks (NNs). Moreover, a “deep neural network,” in the context of deep learning, may refer to an NN that utilizes multiple hidden layers between input and output layers, which may allow for learning based on features not explicitly defined in raw data. As used in the present application, any feature identified as an NN refers to a deep neural network. In various implementations. NNs may be trained as classifiers and may be utilized to perform image processing, audio processing, or natural-language processing, to name a few examples.

As further shown in FIG. 1, system 100 is implemented within a use environment including content owner 126, content distributor 127, which may be a subscription video on demand (SVOD) platform or a content distribution network (CDN) for example. In addition the use environment of system 100 includes consumer devices 140a. 140b, and 140c (hereinafter “consumer devices 140a-140c”) utilized by respective consumers 128a, 128b, and 128c (hereinafter “consumers 128a-128c”) to request content or modification of content via communication network 130 and network communication links 132. Also shown in FIG. 1 are displays 148a. 148b, and 148c (hereinafter “displays 148a-148c”) of respective consumer devices 140a-140c, content modification requests 120, existing or original content 122 (hereinafter “content 122”), and modified content 124 corresponding to content 122.

It is noted that in some implementations, as shown in FIG. 1, alternate content database 108 and modified content database 118 may be stored in system memory 106. However, in other implementations, one or both of alternate content database 108 and modified content database 118 may be remote from, but communicatively coupled to computing platform 102. It is further noted that although FIG. 1 shows one content owner 126, one content distributor 127, and three consumers 128a-128c, system 100 may provide automated user-initiated content modification services to multiple content owners, multiple content distributors, and thousands or millions of consumers, for example.

Although the present application refers to software code 116, trained ML model(s) 114, alternate content database 108, and modified content database 118 as being stored in system memory 106 for conceptual clarity, more generally, system memory 106 may take the form of any computer-readable non-transitory storage medium. The expression “computer-readable non-transitory storage medium,” as used in the present application, refers to any medium, excluding a carrier wave or other transitory signal that provides instructions to processing hardware 104 of computing platform 102. Thus, a computer-readable non-transitory storage medium may correspond to various types of media, such as volatile media and non-volatile media, for example. Volatile media may include dynamic memory, such as dynamic random access memory (dynamic RAM), while non-volatile memory may include optical, magnetic, or electrostatic storage devices. Common forms of computer-readable non-transitory storage media include, for example, optical discs such as DVDs, RAM, programmable read-only memory (PROM), erasable PROM (EPROM), and FLASH memory.

It is further noted that although FIG. 1 depicts software code 116, trained ML model(s) 114, alternate content database 108, and modified content database 118 as being mutually co-located in system memory 106 that representation is also merely provided as an aid to conceptual clarity. More generally, system 100 may include one or more computing platforms, such as computer servers for example, which may be co-located, or may form an interactively linked but distributed system, such as a cloud-based system, for instance. As a result, processing hardware 104 and system memory 106 may correspond to distributed processor and memory resources within system 100. Thus, it is to be understood that software code 116, trained ML model(s) 114, alternate content database 108, and modified content database 118 may be stored remotely from one another within the distributed memory resources of system 100. It is also noted that, in some implementations, trained ML model(s) 114 may take the form of one or more software modules included in software code 116.

Processing hardware 104 may include multiple hardware processing units, such as one or more central processing units, one or more graphics processing units, and one or more tensor processing units, one or more field-programmable gate arrays (FPGAs), custom hardware for machine-learning training or inferencing, and an application programming interface (API) server, for example. By way of definition, as used in the present application, the terms “central processing unit” (CPU). “graphics processing unit” (GPU), and “tensor processing unit” (TPU) have their customary meaning in the art. That is to say, a CPU includes an Arithmetic Logic Unit (ALU) for carrying out the arithmetic and logical operations of computing platform 102, as well as a Control Unit (CU) for retrieving programs, such as software code 116, from system memory 106, while a GPU may be implemented to reduce the processing overhead of the CPU by performing computationally intensive graphics or other processing tasks. A TPU is an application-specific integrated circuit (ASIC) configured specifically for artificial intelligence (AI) processes such as machine learning.

In some implementations, computing platform 102 may correspond to one or more web servers, accessible over a packet-switched network such as the Internet, for example. Alternatively, computing platform 102 may correspond to one or more computer servers supporting a private wide area network (WAN), local area network (LAN), or included in another type of limited distribution or private network. Furthermore, in some implementations, system 100 may be implemented virtually, such as in a data center. For example, in some implementations, system 100 may be implemented in software, or as virtual machines.

It is also noted that, although consumer devices 140a-140c are shown variously as desktop computer 140a, smartphone or tablet computer 140b, and smart television (smart TV) 140c, in FIG. 1, those representations are provided merely by way of example. In other implementations, consumer devices 140a-140c may take the form of any suitable mobile or stationary computing devices or systems that implement data processing capabilities sufficient to provide a user interface, support connections to communication network 130, and implement the functionality ascribed to consumer devices 140a-140c herein. That is to say, in other implementations, one or more of consumer devices 140a-140c may take the form of a laptop computer, digital media player, game console, or a wearable communication device such as a smartwatch, to name a few examples. Moreover, displays 148a-148c of respective consumer devices 140a-140c may take the form of liquid crystal displays (LCDs), light-emitting diode (LED) displays, organic light-emitting diode (OLED) displays, quantum dot (QD) displays, or any other suitable display screens that perform a physical transformation of signals to light.

Content 122 may be streaming digital media content that includes a standard definition (SDR), high-definition (HD), ultra-HD (UHD), high dynamic range (UHD-HDR) or any other video formats with embedded audio, captions such as subtitles, time code, and other ancillary metadata, such as ratings, parental guidelines, or both. In some implementations, content 122 may also include multiple audio tracks, and may utilize secondary audio programming (SAP), Descriptive Video Service (DVS), or both, for example. In various implementations, content 122 may be movie content, TV programming content, live streaming news or sporting events, or video game content, to name a few examples. Communication network 130 may take the form of a packet-switched network, for example, such as the Internet.

By way of overview, in various implementations of the present novel and inventive concepts, system 100 or consumer device 140a-140c may be configured to advantageously provide modified content 124 in real-time relative to receiving content modification request 120. For example, in some implementations, system 100 or consumer device 140a-140c may be configured to provide modified content 124 in real-time or within less than ten seconds of receiving content modification request 120. However, in use cases in which global modifications are made across substantially all instantiations of a title, or across all titles commonly owned by content owner 126 or distributed by content distributor 127, execution of the present user-initiated content modification solution may take significantly longer, such as minutes or hours, rather than a few seconds.

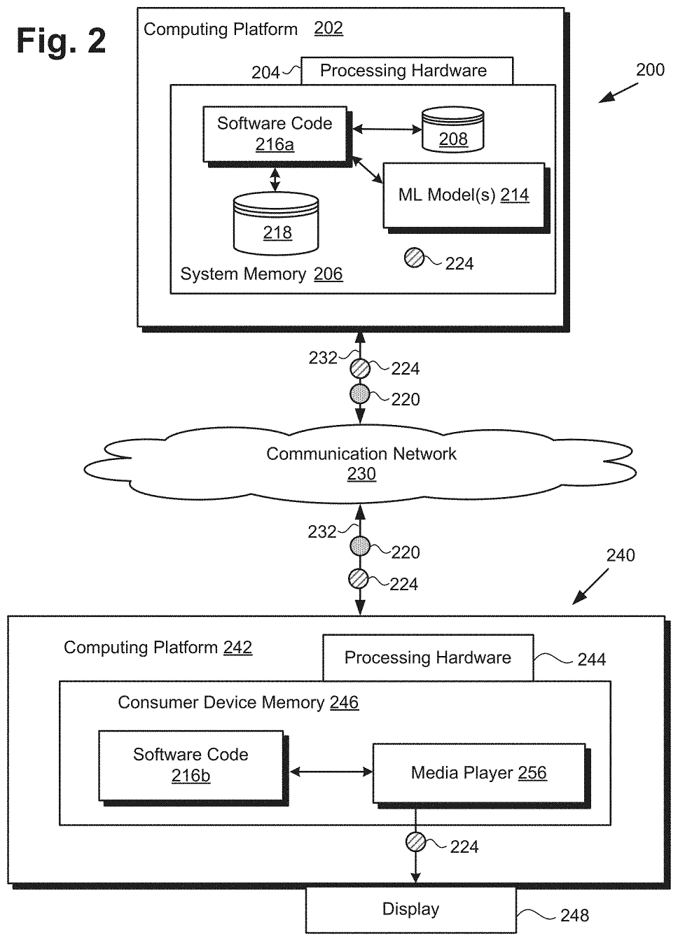

FIG. 2 shows a more detailed diagram of consumer device 240 communicatively coupled to automated system 200 for performing user-initiated content modification, according to one implementation. As shown in FIG. 2, consumer device 240 includes consumer device computing platform 242 having consumer device processing hardware 244, media player 256, modified content 224, and consumer device memory 246 implemented as a computer-readable non-transitory storage medium storing software code 216b. Consumer device 240 also includes display 248, which may be physically integrated with consumer device 240 or may be communicatively coupled to but physically separate from consumer device 240. For example, where consumer device 240 is implemented as a smartphone, laptop computer, or tablet computer, display 248 will typically be integrated with consumer device 240. By contrast, where consumer device 240 is implemented as a desktop computer, display 248 may take the form of a monitor separate from consumer device computing platform 242 in the form of a computer tower.

As further shown in FIG. 2, consumer device 240 is utilized in a use environment including system 200, communication network 230, and network communication links 232. System 200 includes computing platform 202 having processing hardware 204 and system memory 206 implemented as a computer-readable non-transitory storage medium storing software code 216a, and in some implementations, one or more trained ML models 214 (hereinafter “trained ML model(s) 214”), alternate content database 208, and modified content database 218. Also shown in FIG. 2 is content modification request 220 transmitted by consumer device 240 to system 200 via communication network 230 and network communication links 232.

System 200 including computing platform 202 having processing hardware 204 and system memory 206 storing software code 216a, trained ML model(s) 214, alternate content database 208, and modified content database 218, corresponds in general to system 100 including computing platform 102 having processing hardware 104 and system memory 106 storing software code 116, trained ML model(s) 114, alternate content database 108, and modified content database 118, in FIG. 1. In other words, system 200, computing platform 202, processing hardware 204, system memory 206, software code 216a, trained ML model(s) 214, alternate content database 208, and modified content database 218 may share any of the characteristics attributed to respective system 100, computing platform 102, processing hardware 104, system memory 106, software code 116, trained ML model(s) 114, alternate content database 108, and modified content database 118 by the present disclosure, and vice versa. For example, in some implementations, system 200, like system 100, may include one or more computing platforms, such as computer servers for example, which may be co-located, or may form an interactively linked but distributed system, such as a cloud-based system. Thus, in some implementations, system 100/200 may be a cloud-based system.

In addition, communication network 230, network communication links 232, content modification request 220, and modified content 224, in FIG. 2, correspond respectively in general to communication network 130, network communication links 132, content modification requests 120, and modified content 124, in FIG. 1. Thus, communication network 230, network communication links 232, content modification request 120, and modified content 224 may share any of the characteristics attributed to respective communication network 130, network communication links 132, content modification requests 120, and modified content 124 by the present disclosure, and vice versa.

Consumer device 240 and display 248 correspond respectively in general to any or all of respective consumer devices 140a-140c and displays 148a-148c in FIG. 1. Thus, consumer devices 140a-140c and displays 148a-148c may share any of the characteristics attributed to respective consumer device 240 and display 248 by the present disclosure, and vice versa. That is to say, like displays 148a-148c, display 248 may take the form of an LCD, LED display. OLED display, or QD display, for example. Moreover, although not shown in FIG. 1, each of consumer devices 140a-140c may include features corresponding respectively to consumer device computing platform 242, consumer device processing hardware 244, media player 256, modified content 224, and consumer device memory 246 storing software code 216b. It is noted that consumer device processing hardware 244 may include multiple hardware processing units, such as one or more CPUs, one or more GPUs, one or more TPUs, and one or more FPGAs, for example, as those features are defined above.

According to the exemplary implementation shown in FIG. 2, software code 216b is located in consumer device memory 246, subsequent to download of software code 216b to consumer device 140a-140c/240 over a packet-switched network, such as the Internet, for example. Once present on consumer device 140a-140c/240, software code 216b may be persistently stored in consumer device memory 246 and may be executed locally on consumer device 140a-140c/240 by consumer device processing hardware 244. It is noted that software code 216b may be a thin client application of software code 116/216a enabling consumer 128a-128c to utilize consumer device 140a-140c/240 to provide modification request 120/220 to system 100/200 for processing, and to receive modified content 124/224 for rendering on display 148a-148c/248.

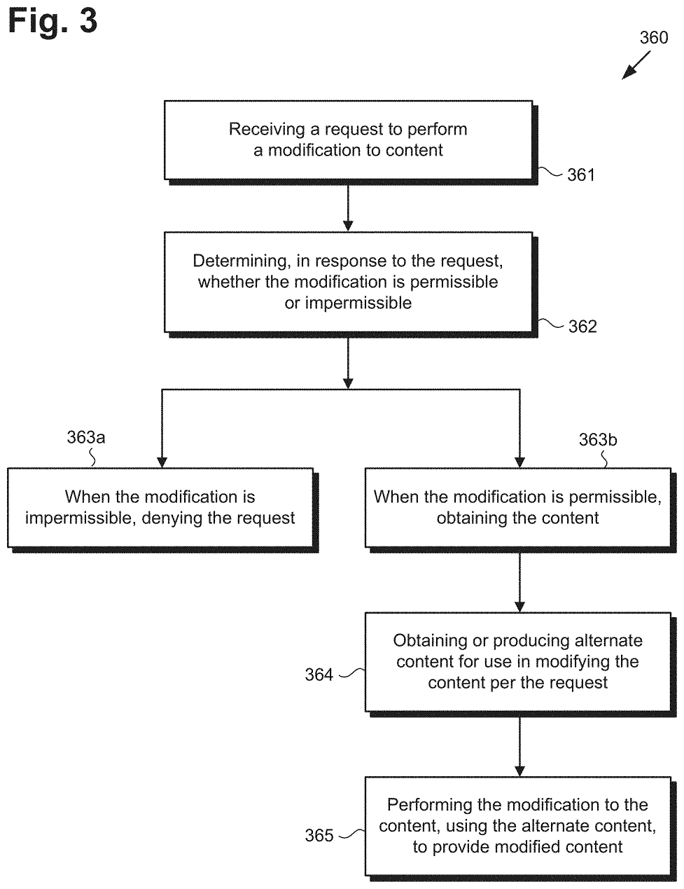

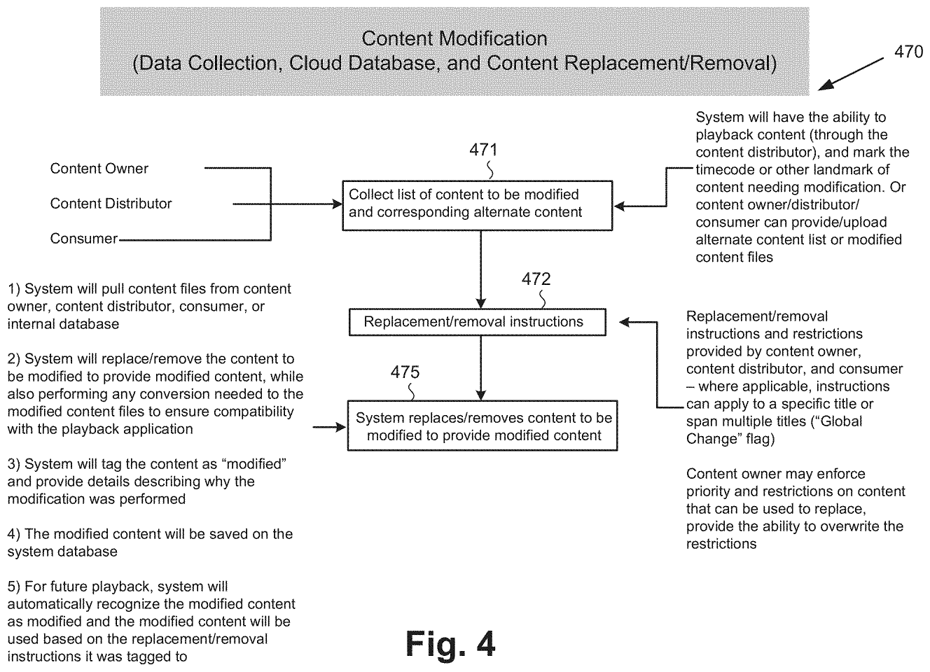

The functionality of system 100/200 and consumer device 140a-140c/240, in FIGS. 1 and 2 will be further described by reference to FIGS. 3 and 4. FIG. 3 shows flowchart 360 outlining an exemplary method for performing user-initiated content modification, according to one implementation, while FIG. 4 shows flow diagram 470 outlining a process for data collection, content modification, and storage of modified content, according to one implementation. With respect to the actions outlined in FIGS. 3 and 4, it is noted that certain details and features have been left out of flowchart 360 and flow diagram 470 in order not to obscure the discussion of the inventive features in the present application.

Referring to FIG. 3 in combination with FIGS. 1 and 2, flowchart 360 begins with receiving content modification request 120/220 to perform a modification to content 122 (action 361). As noted above, content 122 may be streaming digital media content that includes an HD or UHD video signal with embedded audio, captions such as text subtitles, time code, and other ancillary metadata, such as ratings, parental guidelines, or both. As also noted above, in some implementations, content 122 may further include multiple audio tracks. In various implementations, content 122 may be movie content. TV programming content, live streaming news or sporting events, or video game content, to name a few examples.

The modification to content 122 requested in content modification request 120/220 may include a modification to one or more of a subtitle, an audio component, or a video component of content 122. In some use cases, the modification to content 122 requested in content modification request 120/220 removes, blocks, or replaces an undesirable or non-preferred expression (hereinafter “undesirable expression”) included in content 122, such as one or more of text, speech, a gesture, a posture, or a facial expression, for example. Moreover, in some use cases the modification to content 122 requested in content modification request 120/220 removes, blocks, or replaces an undesirable or non-preferred image (hereinafter “undesirable image”) included in content 122. While in some cases the undesirable expression/image may be deemed unsuitable or offensive by the user initiating the content modification request 120/220, in other cases, the user may just simply prefer one expression/image to another. It is noted that, in some use cases, content modification request 120/220 may include alternate content or a list of alternate content (hereinafter “alternate content list”) for use in modifying content 122.

Referring to FIG. 4 in combination with FIG. 3, as shown by block 471 corresponding in general to action 361 of flowchart 360, action 361 may cause system 100/200 or consumer device 140a-140c/240 to collect a list of original content 122 to be modified and corresponding alternate content. It is noted that the list of original content 122 to be modified may include a list of content titles to be modified, or may identify a portion of a content title, such as a frame, shot, or scene to be modified. System 100/200 will have the ability to playback content through content distributor 127, and mark the timecode or other landmark of the content needing modification. Alternatively, content owner 126, content distributor 127, or consumer 128a-128c/228 can provide the alternate content list or modified content files.

Examples of the various ways in which the alternate content may be obtained may include having consumers 128a-128c/228 enter the desired substitution or deletion into software code 216b. As noted above, software code 216b may be a thin client application of software code 116/216a enabling consumer 128a-128c to utilize consumer device 140a-140c/240 to provide modification request 120/220 to system 100/200 for processing, and to receive modified content 124/224 for rendering on display 148a-148c/248. Alternatively, or in addition, content owner 126 or content distributor 127 may provide suggestions as to what content constitutes an appropriate replacement for the content to be modified. In some implementations, those content owner or content distributor provided suggestions may be based on alternate content identified by trained ML model(s) 114.

In some use cases, the requested modification to content 122 may require full end-to-end modification of content 122. It is noted that such full end-to-end modification of content 122 may be provided uniquely for one of consumers 128a-128c/228 or one of content distributors 127, for a subgroup of consumers 128a-128c/228 or content distributors 127, or may result in a global change to the source file of content 122. In use cases in which the requested modification to content 122 requires full end-to-end modification of content 122, that modification will typically be performed by content owner 126.

However, in other use cases, the requested modification to content 122 may require modification of only a portion or portions of content 122. In some of those instances, content modification request 120/220 may identify the specific timecodes or frames at which content 122 is to be modified. Alternatively, software code 116/216a or 216b may be configured to determine the timecodes or frames of content 122 corresponding to the content to be modified based on a description of that content included in content modification request 120/220. It is noted that in use cases in which only a portion or portions of content 122 requires modification, that modification may be performed by content owner 126 or content distributor 127.

Referring to FIGS. 1, 2, and 3 in combination, in various implementations, content modification request 120/220 may be received by system 100/200 in action 361 from one or more of content owner 126, content distributor 127, and consumers 128a-128c/228 via communication network 130/230 and network communication links 132/232. In those implementations, content modification request 120/220 may be received by software code 116/216a, executed by processing hardware 104/204 of system 100/200. However, in other implementations, content modification request 120/220 may be received in action 361 as an input to consumer device 140a-140c/240 by consumer 128a-128c/228, and may be received by software code 216b, executed by consumer device processing hardware 244.

In the interests of conceptual clarity, and despite the wide variety of different use cases to which the present novel and inventive concepts may be applied, the actions outlined by flowchart 360 will be accompanied by a specific but merely exemplary use case in which a content distribution platform requests that all content distributed via their platform have the word “masticate” substituted by the word “chew” in both speech and subtitles. Thus, according to this specific use case, content modification request 120/220 to perform a modification to content 122 is received by software code 116/216a, executed by processing hardware 104/204 of system 100/200, in action 361, from content distributor 127.

Flowchart 360 further includes determining, in response to content modification request 120/220, whether the requested modification is permissible or impermissible (action 362). Action 362 may be performed based on replacement or removal instructions specified by content owner 126 or content distributor 127, for example, as indicated by block 472 of flow diagram 470. That is to say, replacement instructions, removal instructions, and restrictions on modification of content 122 may be provided by content owner 126, content distributor 127, or, in some use cases, by consumers 128a-128c/228. Such instructions and restrictions can apply to a specific title or span multiple titles, i.e., may function as “Global Change” flags. In some implementations, content owner 126 may enforce priority and restrictions on alternate content that can be used to modify content 122, as well as to provide the ability to overwrite those restrictions under specific circumstances. Action 362 may be performed by software code 116/216a, executed by processing hardware 104/204 of system 100/200, or by software code 216b, executed by consumer device processing hardware 244 of consumer device 140a-140c/240.

In the exemplary use case described above, in which content distributor 127 requests that all content distributed via their platform have the word “masticate” substituted by the word “chew” in both speech and subtitles, action 362 may be performed based on replacement or removal instructions specified by content owner 126.

Flowchart 360 further includes denying content modification request 120/220 when the requested modification to content 122 is determined to be impermissible in action 362 (action 363a). Action 363a may be performed by software code 116/216a, executed by processing hardware 104/204 of system 100/200, or by software code 216b, executed by consumer device processing hardware 244 of consumer device 140a-140c/240, and based on the determination performed in action 362. In the exemplary use case described above, in which content distributor 127 requests that all content distributed via their platform have the word “masticate” substituted by the word “chew” in both speech and subtitles, action 363a may include informing content distributor 127 that content modification request 120/220 has been denied by content owner 126.

In use cases in which the modification requested in content modification request 120/220 is determined to be impermissible in action 362, the method outlined by flowchart 360 may conclude with action 363b, described above (i.e., no modification of content 122 takes place in response to the denied content modification request). However, in use cases in which the modification requested in content modification request 120/220 is determined to be permissible in action 362, flowchart 360 further includes obtaining content 122 (action 363b). In various implementations, content 122 may be obtained from content owner 126 or content distributor 127. Action 363a may be performed by software code 116/216a, executed by processing hardware 104/204 of system 100/200, or by software code 216b, executed by consumer device processing hardware 244 of consumer device 140a-140c/240. In the exemplary use case described above, in which content distributor 127 requests that all content distributed via their platform have the word “masticate” substituted by the word “chew” in both speech and subtitles, action 363b may include obtaining content 122 from content owner 126.

In use cases in which the modification requested in content modification request 120/220 is determined to be permissible in action 362, flowchart 360 further includes obtaining or producing alternate content for use in modifying content 122 per content modification request 120/220 (action 364). As noted above, in various use cases, the modification to content 122 requested by content modification request 120/220 may include the replacement of content included in content 122, or removal but not replacement of that content. Consequently, as defined for the purposes of the present application, the expression “alternate content” refers to any of the following: 1) replacement content or visual filters such as blur or color filters, for example, that effectively remove text or imagery without replacing the removed content with other speech, text, or imagery, 2) environmental effects filters such as flash, smog, or rain effects, for example, that substitute those effects for undesirable speech, text, or imagery, 3) enabling the pasting of visual stickers, e.g., a sticker reading “censored” that can be pasted on individual frames, at specific timecodes, or across frame or a timecode sequences, 4) freeze frame effects, 5) and bleeping or muting that effectively removes speech or other sounds without necessary replacing speech with speech or sounds with sounds.

In some use cases, the alternate content may have been produced and provided to system 100/200 by content owner 126, content distributor 127, or consumer 128a-128c/228. In those use cases, action 364 may include obtaining that alternate content from alternate content database 108 of system 100/200, or from content modification request 120/220 itself. Thus, in the exemplary use case described above, in which content distributor 127 requests that all content distributed via their platform have the word “masticate” substituted by the word “chew” in both speech and subtitles, the alternate content specified to be obtained in action 364 may be obtained from content modification request 120 provided by content distributor 127. However, in other use cases, the alternate content may not have been previously provided to system 100/200. In those use cases, action 364 may include producing the alternate content dynamically, i.e., “on-the-fly.”

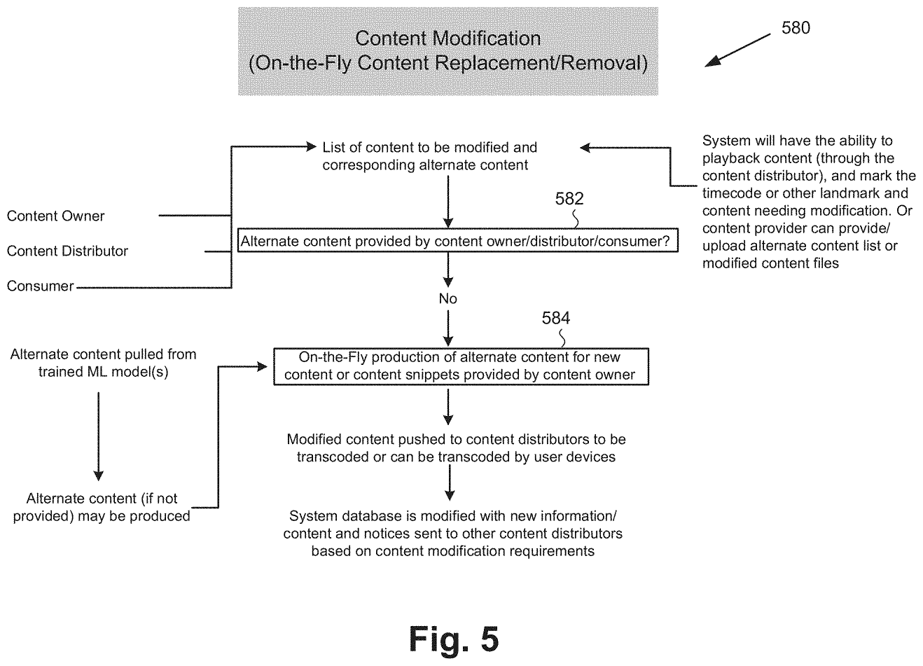

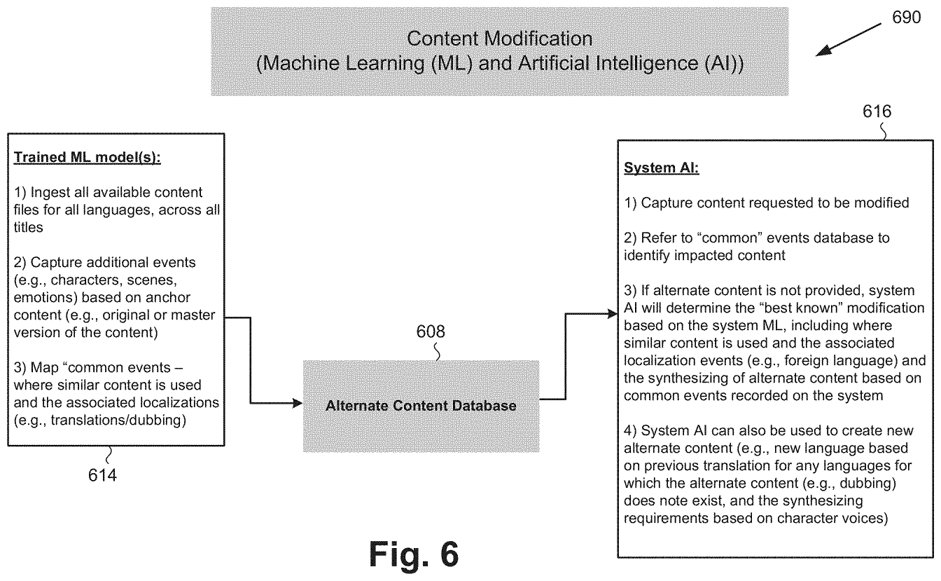

Referring to FIGS. 5 and 6, FIG. 5 shows flow diagram 580 outlining a process for modifying content on-the-fly, according to one implementation, while FIG. 6 shows flow diagram 690 outlining a process for producing alternate content for use in modifying existing content, according to one implementation. As shown by blocks 582 and 584 of flow diagram 580, when alternate content for use in modifying content 122 has not been provided by content owner 126, content distributor 127, or consumer 128a-128c/228, that alternate content can be produced on-the-fly. As further indicated by FIG. 5, such on-the-fly production of alternate content may be performed using trained ML model(s) 114/216, in FIGS. 1 and 2.

Flow diagram 690 in FIG. 6 describes the production of alternate content for modifying content 122, in FIG. 1, in greater detail. As shown in FIG. 6, alternate content database 608 receives the output of one or more trained ML models 614 (hereinafter “trained ML model(s) 614”) and is accessed by software code 616, which produces alternate content on-the-fly using AI. It is noted that alternate content database 608, trained ML model(s) 614, and software code 616 correspond respectively in general to alternate content database 108/208, trained ML model(s) 114/214, and software code 116/216a/216b, in FIGS. 1 and 2. Consequently, alternate content database 108/208, trained ML model(s) 114/214, and software code 116/216a/216b may share any of the characteristics attributed to respective alternate content database 608, trained ML model(s) 614, and software code 616 by the present disclosure, and vice versa.

Referring to FIG. 6 in combination with FIGS. 1 and 2, trained ML model(s) 114/214/614 may be configured to 1) ingest all available content files of content 122 for all languages, across all titles, 2) capture additional events (e.g., characters, scenes, emotions) based on anchor content (e.g., the original or master version of content 122), and 3) map common events and associated localizations between events included in content 122 and similar content, including translations and dubbing. Using the outputs from trained ML model(s) 114/214/614, software code 116/216a/216b/616, when executed by processing hardware 104/204 of system 100/200, or by consumer device processing hardware 244 of consumer device 140a-140c/240, may perform the following: 1) capture content 122 requested to be modified, and 2) refer to the mapped common events to identify impacted content portions of content 122. If alternate content is not provided, the AI performed by software code 116/216a/216b/616 can 3) determine the “best known” modification based on the outputs from trained ML model(s) 114/214/614, including where similar content is used and the associated localization events (e.g., foreign language) and the synthesizing of alternate content based on common events recorded on the system. The AI performed by software code 116/216a/216b/616 can also be used to 4) create new alternate content (e.g., new language based on previous translations for any languages for which the alternate content (e.g., dubbing) does not exist, and the synthesizing requirements based on character voices.

As a specific example of item 4 identified above, where a modification to content 122 includes dubbing in of alternate speech in a language into which the alternate speech has not yet been translated (e.g., Swahili), software code 116/216a/216b/616 may obtain an existing instance of the alternate speech (e.g., an English language dub of the alternate speech) and may translate that alternate content from English to a Swahili dub. Moreover, in some implementations, the vocalization of the dub, in Swahili as well as in English or any other language, may be modulated by software code 116/216a/216b/616 to substantially match the tone and speech pattern of the particular character or actor uttering the alternate content.

In some implementations, action 364 described above may be performed by software code 116/216a/616, executed by processing hardware 104/204 of system 100/200, and using trained ML model(s) 114/214/614. In other implementations, action 364 may be performed by software code 216b/616, executed by consumer device processing hardware 244 of consumer device 140a-140c/240, and using trained ML model(s) 114/214/614.

Referring to FIG. 3 in combination with FIGS. 1 and 2, flowchart 360 also includes performing the modification to content 122 requested by content modification request 120/220, using the alternate content obtained or produced in action 364, to provide modified content 124/224 (action 365). Referring to FIG. 4, block 475 corresponding in general to action 365 describes action 365 as replacement or removal of content to be modified to provide modified content 124/224. As further described by the inputs to block 475, once content 122 has been pulled or otherwise obtained from content owner 126, content distributor 127, consumer 128a-128c/228, or an internal database, system 100/200 or consumer device 140a-140c/240 will replace or remove the content to be modified to provide modified content 124/224, while also performing any conversion needed to the modified content files to ensure compatibility with the playback application used by media player 256 of consumer device 140a-140c/240. In addition, system 100/200 or consumer device 140a-140c/240 may tag content 122 as “modified” and provide details describing why the modification was performed.

In some implementations, action 365 described above may be performed by software code 116/216a/616, executed by processing hardware 104/204 of system 100/200. For example, in the exemplary use case described above, in which content distributor 127 requests that all content distributed via their platform have the word “masticate” substituted by the word “chew” in both speech and subtitles, action 365 may be performed by processing hardware 104/204 of system 100/200.

However, in other implementations, action 365 may be performed by software code 216b/616, executed by consumer device processing hardware 244 of consumer device 140a-140c/240. By way of example, in some implementations in which the modification to content 122 is performed by consumer device 140a-140c/240, that modification to content 122 using the alternate content obtained or produced in action 364 may occur during transcoding of content 122 by consumer device 140a-140c/240, thereby providing modified content 124/224.

It is noted that, in some implementations, system 100/200 or consumer device 140a-140c/240 may be configured to advantageously provide modified content 124/224, in action 365, in real-time relative to receiving content modification request 120/220 in action 361. For example, in some implementations, system 100/200 or consumer device 140a-140c/240 may be configured to provide modified content 124/224 within less than ten seconds of receiving content modification request 120/220 in action 361. However, in use cases in which global modifications are made across substantially all instantiations of a title, or across all titles commonly owned by content owner 126 or distributed by content distributor 127, the method outlined by flowchart 360 may take significantly longer, such as minutes or hours, rather than a few seconds.

Modified content 124/224 may be saved in system memory 106/206 of computing platform 102/202, such as in modified content database 118/218. In addition, or alternatively, modified content 124/224 may be stored on consumer device memory 246. For future playback, system 100/200 or consumer device 140a-140c/240 may automatically recognize modified content 124/224 as modified, and modified content 124/224 will be used based on the replacement or removal instructions tagged to it.

With respect to the method outlined by flowchart 360, it is emphasized that actions 361, 362, 363a, or actions 361, 362, 363b, 364, and 365, may be performed in an automated process from which human participation may be omitted.

Thus, present application discloses automated systems and methods for performing user-initiated content modification. The user-initiated content modification solution disclosed herein advantageously advances the state-of-the-art by enabling content modification that is faster and less costly than existing techniques. The present solution is faster at least in part because the content modification can be performed on consumer device 140a-140c/240. The present solution is less costly at least in part because it does not require content owner 126 or content distributor 127 to frequently update content source files. In addition, the present solution advantageously enables a variety of content stakeholders to initiate content modifications with little or no lag time relative to changes in consumer sensibilities regarding what constitutes undesirable language or imagery.

From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described herein, but many rearrangements, modifications, and substitutions are possible without departing from the scope of the present disclosure.

1: A system comprising:
a computing platform including processing hardware and a system memory storing a software code;
the processing hardware configured to execute the software code to:
receive a request to perform a modification to a first content;
determine, in response to the request, whether the modification is permissible or impermissible;
when the modification is determined to be impermissible, deny the request;
when the modification is determined to be permissible:
obtain the first content;
obtain or produce a second content for use in modifying the first content per the request; and
perform the modification to the first content, using the second content, to provide a third content.

2: The system of claim 1, wherein the modification to the first content modifies at least one of a subtitle, an audio component, or a video component of the first content.

3: The system of claim 1, wherein the modification to the first content removes, blocks, or replaces an expression included in the first content.

4: The system of claim 3, wherein the expression comprises at least one of text, speech, a gesture, a posture, or a facial expression.

5: The system of claim 1, wherein the modification to the first content removes, blocks, or replaces an image included in the first content.

6: The system of claim 1, wherein the system is implemented as a consumer device, and wherein the software code is an application stored on the consumer device.

7: The system of claim 6, wherein the modification to the first content using the second content occurs during transcoding of the first content by the consumer device, thereby providing the third content.

8: The system of claim 1, wherein the system comprises a cloud-based system.

9: The system of claim 1, wherein the system memory further stores at least one trained machine learning (ML) model, and wherein the processing hardware is further configured to execute the software code to:
produce the second content using the at least one trained ML model.

10: The system of claim 1, wherein the third content is provided in real-time relative to receiving the request.

11: The system of claim 1, wherein the request is received from one of an owner, a distributor, or a consumer of the first content.

12: A method for use by a system including a computing platform having processing hardware and a system memory storing a software code, the method comprising:
receiving, by the software code executed by the processing hardware, a request to perform a modification to a first content;
determining, by the software code executed by the processing hardware in response to the request, whether the modification is permissible or impermissible;
when the modification is determined to be impermissible, denying the request by the software code executed by the processing hardware;
when the modification is determined to be permissible:
obtaining, by the software code executed by the processing hardware, the first content;
obtaining or producing, by the software code executed by the processing hardware, a second content for use in modifying the first content per the request; and
performing the modification to the first content, by the software code executed by the processing hardware and using the second content, to provide a third content.

13: The method of claim 12, wherein performing the modification to the first content modifies at least one of a subtitle, an audio component, or a video component of the first content.

14: The method of claim 12, wherein performing the modification to the first content removes, blocks, or replaces an expression included in the first content.

15: The method of claim 14, wherein the expression comprises at least one of text, speech, a gesture, a posture, or a facial expression.

16: The method of claim 12, wherein performing the modification to the first content removes, blocks, or replaces an image included in the first content.

17: The method of claim 12, wherein the system executing the method is implemented as a consumer device, and wherein the software code is an application stored on the consumer device.

18: The method of claim 17, wherein performing the modification to the first content using the second content occurs during transcoding of the first content by the consumer device, thereby providing the third content.

19: The method of claim 12, wherein the system executing the method comprises a cloud-based system.

20: The method of claim 12, wherein the system memory further stores at least one trained machine learning (ML) model, the method further comprising:
producing the second content, by the software code executed by the processing hardware, using the at least one trained ML model.

21: The method of claim 12, wherein providing the third content occurs in real-time relative to receiving the request.

22: The method of claim 12, wherein the request is received from one of an owner, a distributor, or a consumer of the first content.
